(19) United States
(12) Patent Application Publication
(10) Pub. No.: US 2018/0300854 A1
(43) Pub. Date: Oct. 18, 2018

(54) METHOD AND ELECTRONIC DEVICE FOR RENDERING A PANORAMA IMAGE

(71) Applicant: YANDEX EUROPE AG, Luzern (CH)

(72) Inventor: Kirill Sergeevich DMITRENKO, Nelidovo Village, Volokolamsk D-t (RU)

(21) Appl. No.: 15/526,445

(22) PCT Filed: Apr. 8, 2015
(86) PCT No.: PCT/IB2015/052563

§ 371 Date: May 12, 2017

(30) Foreign Application Priority Data
Jan. 23, 2015 (RU) 2015102056

(51) Int. Cl. G06T 3/40; G06T 15/04; G06T 15/08

(52) U.S. Cl. CPC G06T 3/4038; G06T 15/08; G06T 15/04

(57) ABSTRACT

A computer-implemented method of (800) and an electronic device (208) for rendering a panorama image comprising a first image tile (310) and a second image tile (308). The method (800) comprises receiving the first image tile; generating, by a processor (110, 111), a first intermediate rendering result (404) by associating the first image tile (310) with a first transparent layer (410); and storing, in a non-transitory computer-readable medium (120, 130), the first intermediate rendering result (404). Upon receiving an instruction to render at least a portion of the panorama image, the method may execute accessing the first intermediate rendering result (404) and a second intermediate rendering result (414); merging the first intermediate rendering result (404) and the second intermediate rendering result (414) to render the portion of the panorama image; and displaying, on a display screen (142), the portion of the panorama image.

### CROSS-REFERENCE

The present application claims priority to Russian Patent Application No. 2015102056, filed Jan. 23, 2015, entitled “METHOD OF PROCESSING PANORAMA VIEW RELATED DATA” the entirety of which is incorporated herein

### FIELD

The present technology relates to electronic devices and methods for rendering a panorama image. In particular, the electronic devices and methods aim at generating intermediate rendering results to be used for displaying a panorama image to a user.

### BACKGROUND

Broadly speaking, panorama images are wide-angle views or representations of a physical space—typically a wide area, whether in the form of photography, a movie or a three-dimensional model. Panorama images are used in numerous multimedia applications to provide, for example, a user of an electronic device with a small shot of a wide area while allowing the user to modify her/his virtual position with respect to the wide area and dynamically adapt the visual representation of the wide area accordingly. Examples of multimedia applications relying on panorama images include Yandex.Maps from Yandex™ and Google Maps from Google™. Both Yandex.Maps and Google Maps allow a user to visualize street panorama images on an electronic device by transferring data representing a panorama image or a portion of a panorama image from a server to the electronic device.

In some implementations relating to multimedia applications, a panorama image is modelized by a structured set of triangle tiles defining a representation of a panorama image in the form of a sphere. Each triangle tile represents a sub-portion of the panorama image and is associated with a particular position with respect to the other triangle tiles that are part of the structured set of triangle tiles. In some instances, each triangle tile may be associated with one or more textures representing details of the panorama image. Data associated with each triangle tile allows to store in a memory of a computer-based system, such as a server, a complete structured set of triangle tiles forming a sphere representing a panorama image. Given the number of triangle tiles required to represent a panorama image, the volume of data to be stored in the memory of the computer-based system to modelize an entire panorama image may be substantial. As a result, in some implementations, data modelizing the entire panorama image is hosted on a server and is rarely transferred in its entirety to an electronic device remotely communicating with the server. Under a conventional approach, a software application running on an electronic device of a user and allowing visualizing a panorama image requests the server to transfer data modelizing a portion of the panorama image and not the panorama image as a whole. Data modelizing the portion of the panorama image is limited to the portion of the panorama image to be actually displayed on a display screen of the electronic device and/or data modelizing a region of the panorama image that surrounds the portion of the panorama image to be actually displayed. Therefore, upon requesting data modelizing the portion of the panorama image to a server, the electronic device receives data associated with a structured set of triangle tiles representing the corresponding portion of the panorama image. The data are then stored in a memory of the electronic device for later use by a rendering engine running on the electronic device. In some implementations, in order to allow the electronic device to properly display the portion of the panorama image, the rendering engine extracts each triangle tile required for the corresponding portion of the panorama image and processes each triangle tile to orient it and modify it based on an angle of view selected by the user of the electronic device. The process is repeated for each triangle tile required for representing the corresponding portion of the panorama image. Once all iterations have been completed, the processed triangle tiles are then assembled together to form a collection of rectangles to produce a final representation of portion of the panorama image to be displayed on the display of the electronic device. As a person skilled in the art of the present technology will appreciate, assembling the triangle tiles to form a collection of rectangles is a required step to generate visual content to be displayed by an electronic device which is limited to displaying pixels having a rectangular shape.

Even though the conventional approach of accessing and processing data representing a portion of a panorama image stored on a remote server provides some benefits, such as, limiting the downloading of data to data that is only relevant to the portion of the panorama image to be displayed, a person skilled in the art of the present technology will appreciate that the processing unit load required to run a rendering engine processing each triangle tile and assembling the processed triangle tiles to form the collection of required rectangles is heavy. Running of such rendering engine may therefore negatively impact the user experience by requiring an excessive load on the processing unit of the electronic device.

### SUMMARY

It is an object of present technology to provide improvements, in particular improvements aiming at improving usage of a processing unit of an electronic device to render a panorama image.

In some applications, it is desirable to render a panorama image modelized by data stored on a remote server on an electronic device in communication with the remote server. As set forth in the paragraphs above, processing data modelizing the panorama image received from the remote server on the electronic device may require intensive usage of one or more processing units of the electronic device. Intensive and/or excessive usage of the one or more processing units of the electronic device, such as, for example, the graphics processing unit (GPU), may result in graphics lag and/or accelerated battery drain. The graphics lag typically results in a reduction in the responsiveness of the user control over the displayed panorama image which may negatively impact the user experience. The accelerated battery drain may also result in negatively impacting the user experience as the electronic device may be a mobile device having, at least temporarily, a battery for sole source of power.

The present technology arises from an observation made by the inventor(s) that upon receiving an image tile from a remote server on an electronic device, an intermediate rendering result associating the image tile with a transparent layer may be generated and stored in a memory of the electronic device. Upon receiving an instruction to render at least a portion of the panorama image, the intermediate rendering result may then be accessed from the memory of the electronic device and merged with another intermediate rendering result to render the portion of the panorama image. The present technology therefore allows the electronic device to reduce the processing load of its one or more processing units upon rendering the portion of the panorama image as at least some intermediate rendering results have already been pre-processed. As a result, the present technology, allows, inter alia, generating intermediate rendering results on an electronic device that may then be used to render a panorama image on the electronic device while requiring less processing unit load that it would have been otherwise necessary without the generation of the intermediate rendering results.

Thus, in one aspect, various implementations of the present technology provide computer-implemented method of rendering a panorama image comprising a first image tile and a second image tile, the method comprising:
receiving the first image tile;
generating, by a processor, a first intermediate rendering result by associating the first image tile with a first transparent layer;
storing, in a non-transitory computer-readable medium, the first intermediate rendering result;
upon receiving an instruction to render at least a portion of the panorama image, executing:
   accessing, from the non-transitory computer-readable medium, the first intermediate rendering result;
   accessing, from the non-transitory computer-readable medium, a second intermediate rendering result, the second intermediate rendering result comprising the second image tile associated with a second transparent layer;
   merging the first intermediate rendering result and the second intermediate rendering result to render the portion of the panorama image; and
   displaying, on a display screen, the portion of the panorama image.

In some implementations, the first image tile is a first triangle tile and the second image tile is a second triangle tile.

In some further implementations, the first transparent layer has a width and a height selected so as to fully encompass the first image tile and the second transparent layer has a width and a height selected so as to fully encompass the second image tile.

In some implementations, the first transparent layer and the second transparent layer each has a rectangular shape.

In some further implementations, merging the first intermediate rendering result and the second intermediate rendering result is limited to rendering the portion of the panorama image which is to be displayed on the display screen.

In some implementations, merging the first intermediate rendering result and the second intermediate rendering result comprises merging the first image tile and the second image tile only if the first image tile and the second image tile are to be displayed on the display screen.

In some further implementations, the method further comprises determining whether the portion of the panorama image is to be displayed on the display screen and, if the first intermediate rendering result and the second intermediate rendering result stored in the non-transitory computer-readable medium are not sufficient to render the portion of the panorama image to be displayed on the display screen, perform:
requesting a third image tile associated with the panorama image;
receiving the third image tile;
generating a third intermediate rendering result by associating the third image tile with a third transparent layer, the third intermediate rendering result comprising the third image tile associated with the third transparent layer;
storing, in the non-transitory computer-readable medium, the third intermediate rendering result;
accessing, from the non-transitory computer-readable medium, the third intermediate rendering result; and
merging the first intermediate rendering result, the second intermediate rendering result and the third intermediate rendering result to render the portion of the panorama image to be displayed.

In some implementations, receiving the instruction to render the panorama image is in response to one of receiving a display instruction from a remote server and an interaction of a user with an electronic device.

In some further implementations, merging the first intermediate rendering result and the second intermediate rendering result includes mapping, at least partially, the first intermediate rendering result and the second intermediate rendering result to one of a two-dimensional surface and a three-dimensional surface.

In some implementations, merging the first intermediate rendering result and the second intermediate rendering result includes juxtaposing, at least partially, the first image tile and the second image tile on one of a two-dimensional surface and a three-dimensional surface.

In some further implementations, merging the first intermediate rendering result and the second intermediate rendering result includes overlaying, at least partially, the first intermediate rendering result and the second intermediate rendering result.

In some implementations, the first image tile and the second image tile correspond to a respective portion of a sphere associated with the panorama image.

In some further implementations, associating the first image tile with the first transparent layer includes laying the first image tile on the first transparent layer.

In some implementations, associating the first image tile with the first transparent layer includes coupling the first image tile with a grid texture mapping, the grid texture mapping being associated with the panorama image.

In some further implementations, the panorama image is one of a two-dimensional image and a volumetric image.

In some implementations, the first transparent layer and the second transparent layer define a same transparent layer.

In some further implementations, the first transparent layer and the second transparent layer define two distinct transparent layers.

In other aspects, various implementations of the present technology provide a non-transitory computer-readable medium storing program instructions for rendering a panorama image, the program instructions being executable by a processor of a computer-based system to carry out one or more of the above-recited methods.

In other aspects, various implementations of the present technology provide a computer-based system, such as, for example, but without being limitative, an electronic device comprising at least one processor and a memory storing program instructions for rendering a panorama image, the program instructions being executable by one or more processors of the computer-based system to carry out one or more of the above-recited methods.

In the context of the present specification, unless expressly provided otherwise, an “electronic device”, a “server”, a, “remote server”, and a “computer-based system” are any hardware and/or software appropriate to the relevant task at hand. Thus, some non-limiting examples of hardware and/or software include computers (servers, desktops, laptops, netbooks, etc.), smartphones, tablets, network equipment (routers, switches, gateways, etc.) and/or combination thereof.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a file could include the file itself (i.e. its contents), or it could be a unique file descriptor identifying the file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a diagram of a computer system suitable for implementing the present technology and/or being used in conjunction with implementations of the present technology;

FIG. 2 is a diagram of a networked computing environment in accordance with an embodiment of the present technology;

FIG. 3 is a diagram of a sphere associated with a panorama image, the panorama image comprising multiple image tiles in accordance with an embodiment of the present technology;

FIG. 4 is a diagram illustrating a method of generating intermediate rendering results and merging the intermediate rendering results to render a portion of a panorama image in accordance with an embodiment of the present technology;

FIG. 5 is an example of a panorama image divided into multiple image tiles in accordance with an embodiment of the present technology;

FIGS. 6 and 7 are examples of panorama images rendered in accordance with embodiments of the present technology; and

FIG. 8 is a flowchart illustrating a computer-implemented method implementing embodiments of the present technology.

It should also be noted that, unless otherwise explicitly specified herein, the drawings are not to scale.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

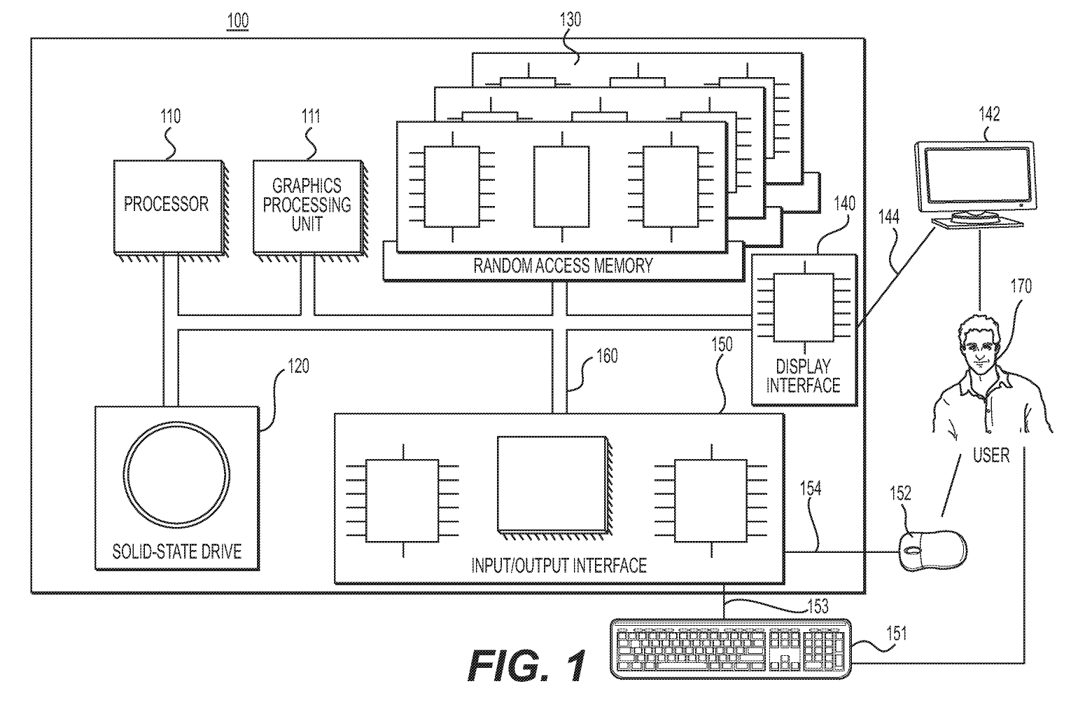

Referring to FIG. 1, there is shown a computer system 100 suitable for use with some implementations of the present technology, the computer system 100 comprising various hardware components including one or more single or multi-core processors collectively represented by processor 110, a graphics processing unit (GPU) 111, a solid-state drive 120, a random access memory 130, a display interface 140, and an input/output interface 150.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled. The display interface 140 may be coupled to a monitor 142 (e.g. via an HDMI cable 144) visible to a user 170, and the input/output interface 150 may be coupled to a touchscreen (not shown), a keyboard 151 (e.g. via a USB cable 153) and a mouse 152 (e.g. via a USB cable 154), each of the keyboard 151 and the mouse 152 being operable by the user 170.

According to implementations of the present technology, the solid-state drive 120 stores program instructions suitable for being loaded into the random access memory 130 and executed by the processor 110 and/or the GPU 111 for rendering a panorama image. For example, the program instructions may be part of a library or an application.

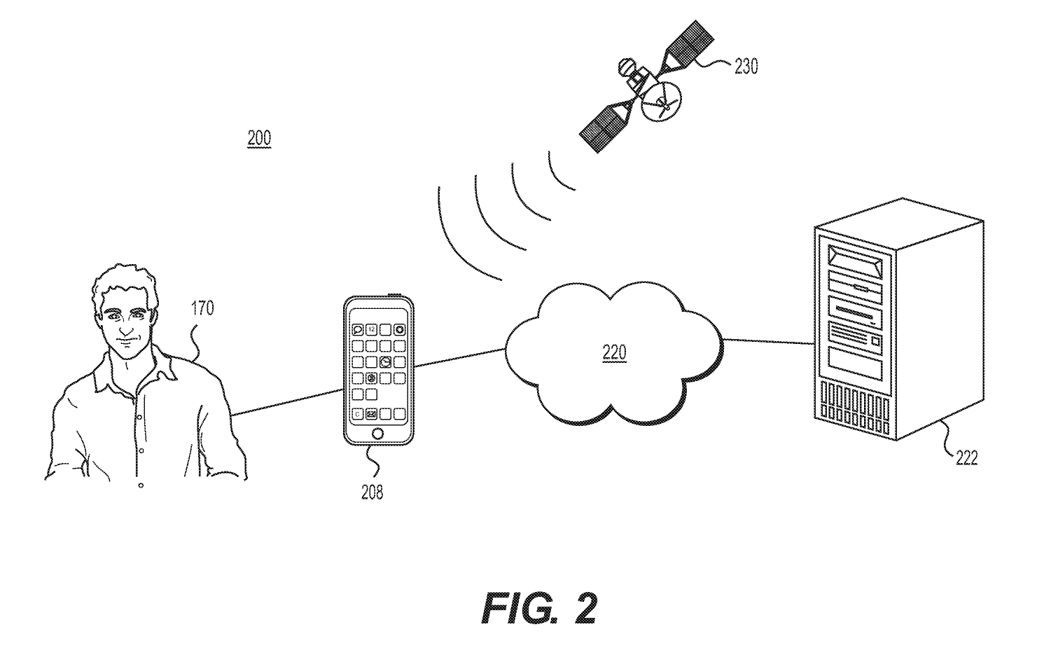

In FIG. 2, there is shown a networked computing environment 200 suitable for use with some implementations of the present technology, the networked computing environment 200 comprising an electronic device 208 (also referred to as a “client device”, an “electronic device” or an “electronic device associated with the user”), a server 222 (also referred to as a “remote server”) in communication with the electronic device 208 via a network 220 (e.g., the Internet) enabling these systems to communicate and a GPS satellite 230 transmitting a GPS signal to the electronic device 208.

The implementation of the electronic device 208 is not particularly limited, but as an example, the electronic device 208 may interact with the server 222 by receiving input from the user 170 and receiving and transmitting data via the network 220. The electronic device 208 may be, for example and without being limitative, a desktop computer, a laptop computer, a smart phone (e.g. an Apple iPhone™ or a Samsung Galaxy SS™), a personal digital assistant (PDA) or any other device including computing functionality and data communication capabilities. The electronic device 208 may comprise internal hardware components including one or more single or multi-core processors collectively referred to herein as processor 110, a GPU 111 and a random access memory 130, each of which is analogous to the like-numbered hardware components of computer system 100 shown in FIG. 1, as well as a network interface (not depicted) for communicating with the server 222. The electronic device 208 may also comprise a GPS receiver (not depicted) for receiving a GPS signal from one or more GPS satellites, such as the satellite 230.

In one embodiment, the electronic device 208 displays content from the server 222 by processing data modelizing one or more panorama images and/or one or more portion of a panorama image received from the server 222. In various embodiments, the electronic device 208 executes a visualisation interface to display a panorama image or a portion of a panorama image to the user 170 through a browser application (not shown) and/or through a dedicated visualisation application (not shown) preinstalled on the electronic device 208. Generally speaking, the purpose of the visualisation interface is to enable the user 170 to (i) select a panorama image (or a portion thereof) to be displayed on the electronic device 208; (ii) receive and/or process data modelizing the selected panorama image; and (iii) display and interact with the selected panorama image.

In an exemplary embodiment, selecting the panorama image (or the portion thereof) to be displayed on the electronic device 208 may be achieved by formulating a search query and executing a search using a search engine that is, for example, hosted on the server 222. To that end, the search interface may comprise a query interface (not shown) in which the user 170 may formulate a search query by interacting, for example, with the touchscreen of the electronic device 208. The search interface may also comprise a search results interface (not shown) to display a result set generated further to the processing of the search query.

In one embodiment, receiving and processing data modelizing the selected panorama image may be achieved by opening a communication channel with the server 222 from which the data modelizing the selected panorama image may be accessible. In some embodiments, the communication channel may be created further to the electronic device 208 sending a request to obtain data relating a specific panorama image or a specific portion of a panorama image to the server 222. In some other instances, the electronic device 208 may include a cookie (not shown) that contains data indicating whether the user 170 of the electronic device 208 is logged into the server 222. The cookie may indicate whether the user 170 is involved in an active session where the electronic device 208 exchanges data with the server 222, providing that the user 170 has an account associated with the server 222. Once the communication channel is established between the electronic device 208 and the server 222, data modelizing the panorama image may be received by the electronic device 208. In some instances, a complete set of data modelizing the entire panorama image is received by the electronic device 208. In some other instances, a specific set of data modelizing a portion of the panorama image is received by the electronic device 208. Determining whether a complete set of data modelizing the entire panorama image or only a specific set of data modelizing a portion of the panorama image is to be received may be determined by the visualisation interface running on the electronic device 208, the server 222 and/or the user 170 interacting with the electronic device 208.

In another embodiment, the data modelizing the panorama image may be previously stored in a memory of the electronic device 208 such as in the solid-state drive 120. In such an embodiment, no communication channel is to be established between the electronic device 208 and the server 222 as the data has been previously stored in the memory of the electronic device 208, for example, upon downloading and installing the visualisation application on the electronic device 208.

Once received by the electronic device 208, the data modelizing the panorama image (or the portion thereof) may be processed, for example by the processor 110 and/or GPU 111 of the electronic device 208. Instructions to carry out the processing of the data may be implemented through a rendering engine controlled by the visualisation interface. Alternatively, the rendering engine may be controlled by a software module independent from the visualisation interface (e.g., the operating system of the electronic device 208). In other embodiments of the present technology, the instructions to carry out the processing may be implemented through a dedicated module (software and/or hardware) or a non-dedicated module (software and/or hardware) without departing from the scope of the present technology.

As it will be described with more details in the paragraphs below, the processing of the data modelizing the panorama image aims at generating intermediate rendering results that are stored in the memory of the electronic device 208 for immediate or later rendering on the display of the electronic device 208. Once generated, the intermediate rendering results are stored in the memory of the electronic device 208 such as, for example, in the solid-state drive 120 and/or the random access memory 130. In some other embodiments, the processing of the data modelizing the panorama image to generate intermediate rendering results may occur on a device different than the electronic device 208. For example, in an alternative embodiment, the processing of the data modelizing the panorama image may occur on the server 222. In this example, the electronic device 208 may receive from the server 222 intermediate rendering results processed by a processor of the server 222 in lieu of receiving the non-processed data modelizing the panorama image. Still under this example, upon receiving the intermediate rendering results, the electronic device 208 stores the intermediate rendering results in the memory of the electronic device 208.

In an exemplary embodiment, the visualisation interface enables the user 170 to display and interact with the selected panorama image. In an exemplary embodiment of the present technology, the visualisation interface may comprise instructions to access the memory of the electronic device 208 in which the intermediate rendering results are stored, for example the solid-state drive 120 and/or the random access memory 130. The visualisation interface may also comprise instructions to merge the intermediate rendering results to render the panorama image (or the portion thereof) to be displayed on the electronic device 208. The visualisation interface may further comprise instructions to display the rendered panorama image (or the portion thereof) on the display of the electronic device 208. In some embodiments of the present technology, upon displaying the panorama image, the visualisation interface may enable the user to interact with the rendered panorama image, for example by allowing the user 170 to modify her/his virtual point of view with respect to the panorama image, zoom-in on a portion of the displayed panorama image and/or zoom-out on a portion of the displayed panorama image. In some embodiments of the present technology, the electronic device 208 and/or the server 222 may determine that, as a result of the interaction of the user 170 with the displayed panorama image, additional data modelizing the panorama image and/or intermediate rendering results generated from the data modelizing the panorama image may be needed. In this particular instance, if the intermediate rendering results are not available in the memory of the electronic device 208, the visualisation interface may prompt the server 222 to send the required data modelizing the panorama image and process the data to generate additional intermediate rendering results. In turn, the additional intermediate rendering results may be merged to render a new panorama image reflecting the interaction of the user 170 with the version of the panorama image previously displayed.

As for the instructions to generate intermediate rendering results, instructions to render the panorama image (or the portion thereof) may be implemented through a rendering engine controlled by the visualisation interface. The rendering engine may be the same as the one used to generate intermediate rendering results but not necessarily. Alternatively, the rendering engine may be controlled by a software module independent from the visualisation interface (e.g., the operating system of the electronic device 208). In other embodiments of the present technology, the instructions to carry out the rendering of the panorama image may be implemented through a dedicated module (software and/or hardware) or a non-dedicated module (software and/or hardware) without departing from the scope of the present technology.

How the visualisation interface is implemented is not particularly limited. One example of the visualisation interface may be embodied in a user accessing a web site associated with the server 222. For example, the visualisation interface may be accessed by typing in an URL associated with the web service Yandex.Maps available at https://maps.vandex.com. In another example, the visualisation interface may be embodied in a software application (also referred to as an “application” or an “app”) to be installed on the electronic device 208. For example, the application implementing the visualisation interface may be downloaded by typing in an URL associated with an application store from which the application may be downloaded, such as, for example, the app Yandex.Maps available for downloading from the Yandex.Store from Yandex corporation of Lev Tolstoy st. 16, Moscow, 119021, Russia or from the Apple's App Store from Apple Inc. corporation of 1 Infinite Loop, Cupertino, Calif. 95014, United States of America. It should be expressly understood that the visualization interface may be accessed using any other commercially available or proprietary web service.

The electronic device 208 is coupled to the network 220 via a communication link (not numbered). In some non-limiting embodiments of the present technology, the network can be implemented as the Internet. In other embodiments of the present technology, the network 220 can be implemented differently, such as any wide-area communications network, local-area communications network, a private communications network and the like.

How the communication link is implemented is not particularly limited and will depend on how the electronic device 208 is implemented. Merely as an example and not as a limitation, in those embodiments of the present technology where the electronic device 208 is implemented as a wireless communication device (such as a smart-phone), the communication link can be implemented as a wireless communication link (such as but not limited to, a 3G communications network link, a 4G communications network link, a Wireless Fidelity, or WiFi®, Bluetooth® and the like). In those examples, where the electronic device 208 is implemented as a notebook computer, the communication link can be either wireless (such as the Wireless Fidelity, or WiFi®, Bluetooth® and the like) or wired (such as an Ethernet based connection).

It should be expressly understood that implementations for the electronic device 208, the communication link and the network 220 are provided for illustration purposes only. As such, those skilled in the art will easily appreciate other specific implementational details for the electronic device 208, the communication link and the network 220. As such, by no means, examples provided herein above are meant to limit the scope of the present technology.

Also coupled to the network 220 is the server 222 (also referred to as the “remote server 222”) on which a web service for providing access to data modelizing one or more panorama image and/or one or more portion of a panorama image may be hosted. The server 222 can be implemented as a conventional computer server. In an example of an embodiment of the present technology, the server 222 can be implemented as a Dell™ PowerEdge™ Server running the Microsoft™ Windows Server™ operating system. Needless to say, the server 222 can be implemented in any other suitable hardware and/or software and/or firmware or a combination thereof. In the depicted non-limiting embodiment of present technology, the server 222 is a single server. In alternative non-limiting embodiments of the present technology, the functionality of the server 222 may be distributed and may be implemented via multiple servers.

The implementation of the server 222 is well known to the person skilled in the art of the present technology. However, briefly speaking, the server 222 comprises a communication interface (not depicted) structured and configured to communicate with various entities (such as the electronic device 208, for example and other devices potentially coupled to the network 220) via the network 220. The server 222 further comprises at least one computer processor (not depicted) operationally connected with the communication interface and structured and configured to execute various processes to be described herein.

The server 222 may be communicatively coupled (or otherwise has access) to a server implementing a search engine and/or a database server hosting data modelizing one or more panorama image and/or one or more portion of a panorama image in accordance with some implementations of the present technology. As such, the server 222 can be sometimes referred to as a “search server”, a “search front-end server”, a “data server” or a “data modelizing panorama images server”. Even though the server 222 is depicted as a single unit, in some embodiments, the functionality of the server 222 may be distributed and may be implemented via multiple servers without departing from the scope of the present technology.

The general purpose of the server 222 is to provide data modelizing one or more panorama image and/or one or more portion of a panorama image to other systems such as, for example, the the electronic device 208. What follows is a description of one non-limiting embodiment of the implementation for the server 222. However, it should be understood that there is a number of alternative non-limiting implementations of the server 222 possible. It should be also expressly understood that in order to simplify the description presented herein below, the configuration of the server 222 has been greatly simplified. It is believed that those skilled in the art will be able to appreciate implementational details for the server 222 and for components thereof that may have been omitted for the purposes of simplification of the description.

Generally speaking the purpose of the server 222 is to (i) receive a request from the electronic device 208; (ii) retrieve data modelizing panorama images from a database hosting data modelizing panorama images; and (iii) transmit the retrieved data to the electronic device 208. How the server 222 is configured to receive the request, retrieve data and transmit data is not particularly limited. Those skilled in the art will appreciate several ways and means to execute the receiving of the request, the retrieving of the data and the transmitting of the data and as such, several structural components of the server 222 will only be described at a high level.

In one embodiment, the server 222 may be configured to receive a request from the electronic device 208 specifically identifying a set of data modelizing a panorama image or a portion of a panorama image. In an alternative embodiment of the present technology, the request received from the electronic device 208 may be a search query which is interpreted and processed by a search engine that may be, for example, hosted on the server 222. Once processed, an identification of a specific set of data modelizing a panorama image associated with the search query may be identified. How the specific set of data is identified is not particularly limited. Once the specific set of data is identified, the server 222 then retrieves the data from a data repository such as, for example, a database server (not depicted) coupled to the server 222. In some embodiments of the present technology, the retrieved data may be processed by the server 222 before transmission to the electronic device 208. In such embodiments, the processing of the data may include generating intermediate rendering results that may be stored in the server 222 or a data server coupled to the server 222. In some embodiments, the intermediate rendering results may be directly transmitted to the electronic device 222 without being stored. In yet some alternative embodiments of the present technology, the retrieved data may be transmitted to the electronic device 208 without being processed by the server 222. In some alternative embodiments of the present technology, the intermediate rendering results may have been pre-generated and stored in the database server. In some embodiments, the server 222 may also trigger the electronic device 208 to render and/or display the panorama image. In some alternative embodiments, triggering the electronic device 208 to render and/or display the panorama image may be carried out by the electronic device 208 or in response to the user 170 interacting with the electronic device 208.

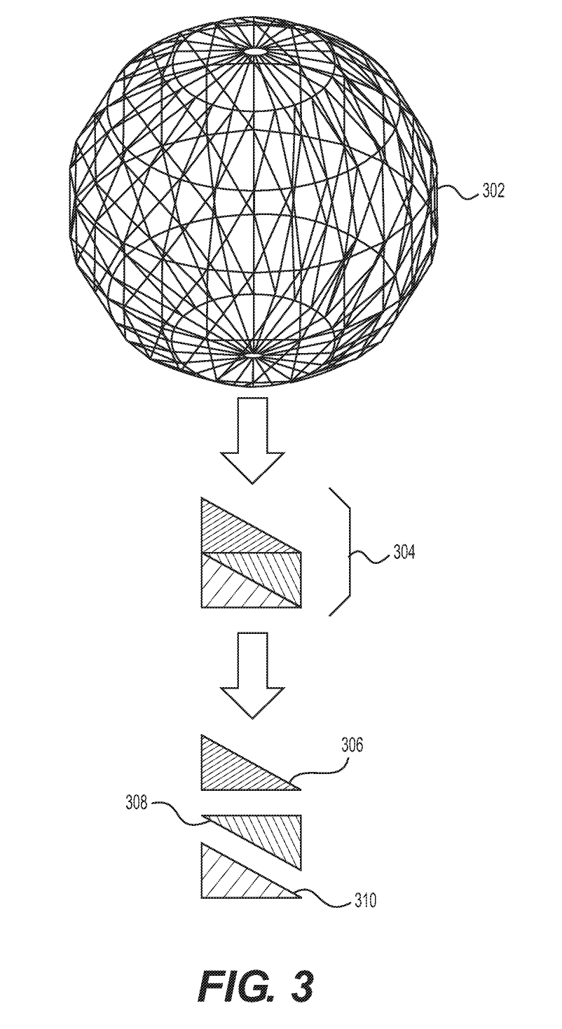

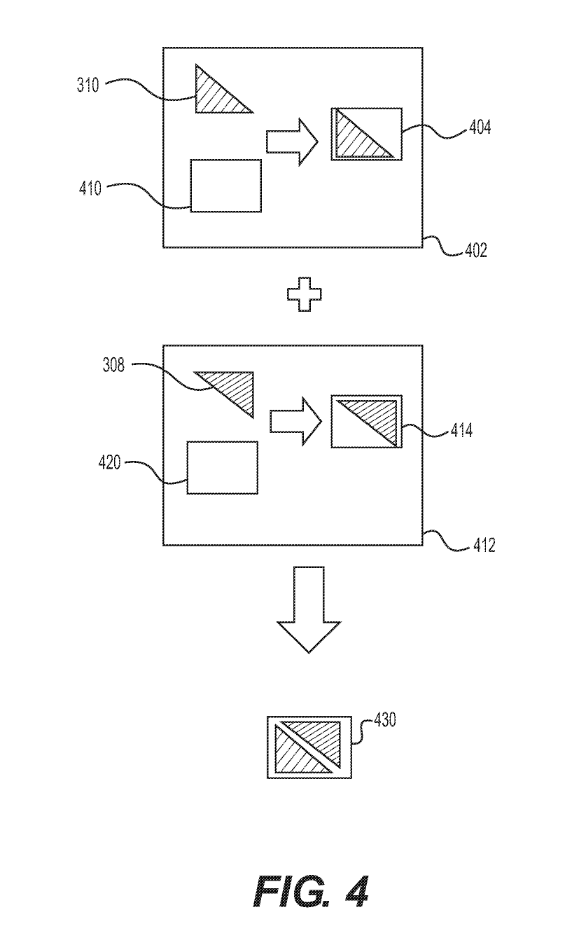

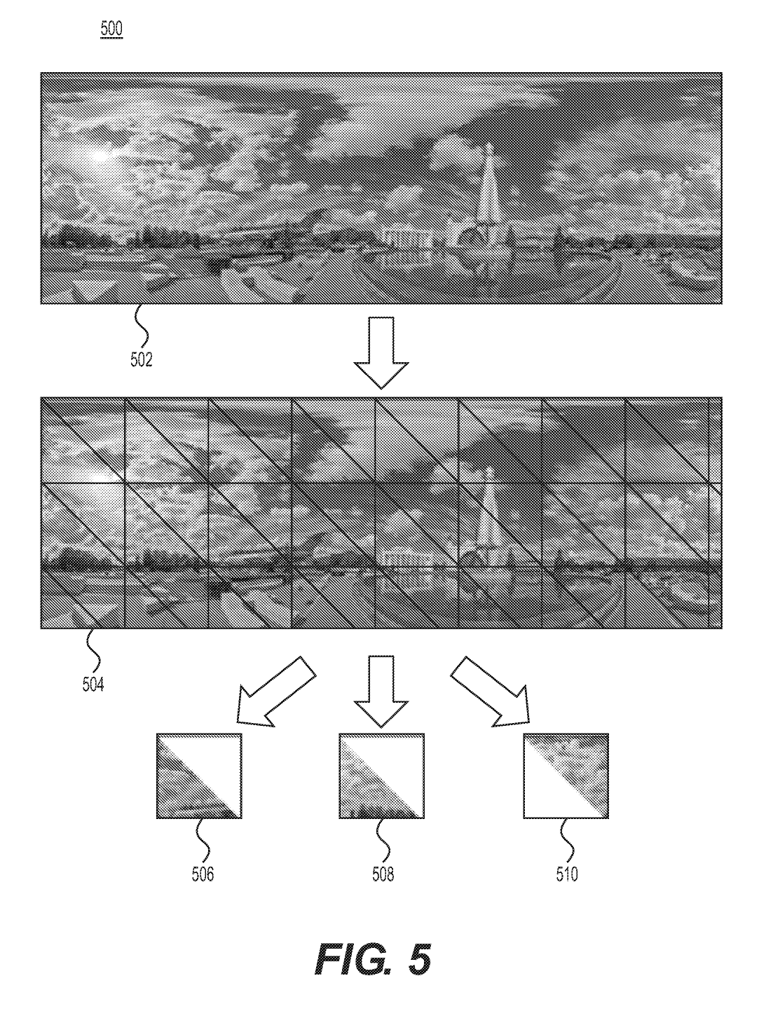

Turning to FIG. 3 and FIG. 4, an embodiment of a method of generating intermediate rendering results from data modelizing a panorama image is depicted. In particular, FIG. 3 illustrates an example of a sphere forming a panorama image 302. Data associated with the sphere modelizes the panorama image 302 so as to be processed and/or stored by a computer-implemented system, such as, for example the electronic device 208 and/or the server 222. In this embodiment of the present technology, the sphere is defined by a structured set of image tiles. Each one of the image tiles may be associated with one or more textures representing details of the panorama image 302 such as, for example, image tiles 506, 508 and 510 shown at FIG. 5. The image tiles may be of various shapes such as triangular shape or rectangular shape. Other variations of the shapes of the image tiles may be equally used without departing from the scope of the present technology. Even though a sphere is illustrated to represent the panorama image 302, it should be understood that other representations are also possible whether in a three-dimensional space or a two-dimensional space. For example, as illustrated at FIG. 5 by a panorama image 502, the panorama image 302 may be a two-dimension picture for mapping a surface or a portion of a surface of a sphere. Other variations of representations of panorama images may be equally used without departing from the scope of the present technology.

The panorama image 302 comprises a plurality of portions of the panorama image, which, when combined together, may form an entire panorama image. As depicted in FIG. 3, a portion 304 of the panorama image 302 comprises three image tiles 306, 308 and 310 (also referred to as a “triangular image tile 306”, a “triangular image tile 308” and a “triangular image tile 310”). Each one of the image tiles 306, 308 and 310 has a triangular shape thereby defining triangular image tiles. Each one of the image tile is associated with an area of the panorama image 302 and is modelized by data allowing a computer-implemented system to process, store and/or display to a user each one of the image tile.

Turning now to FIG. 4, a method of generating intermediate rendering results from the image tiles 310 and 308 is shown along with a method of rendering a portion of the panorama image from the generated intermediate rendering results. A first exemplary execution of the method referred to as 402 illustrates generating an intermediate rendering result 404 by associating the image tile 310 with a transparent layer 410. The transparent layer 410 may be of various shapes such as triangular shape or rectangular shape. Other variations of the shapes of the transparent layers may be equally used without departing from the scope of the present technology. The transparent layer 410 may be modelized by a two-dimensional surface defining an area and may be associated with data allowing such two-dimensional surface to be processed, stored and displayed to a user by a computer-implemented system such as, for example, the electronic device 208 and the server 222. The transparent layer 410 may be associated with no texture and/or no color so as to define a transparent surface which may be superposed to a texture such as the texture of an image tile without interfering with the texture of the image tile. In other words, the transparent layer 410 may cover an image tile without affecting the texture associated with the image tile so as to remain invisible to a user upon being displayed on a display. In some embodiments of the present technology, the transparent layer 410 has a width and height that is selected so as to fully encompass an area defined by the image tile 310 when the image tile 310 and the transparent layer 410 are associated together to generate the intermediate rendering result 404. In some embodiments of the present technology, associating the image tile 310 with the transparent layer 410 includes laying the image tile 310 on the transparent layer 410. In some other embodiments of the present technology, as the transparent layer 410 may be transparent, it is equally feasible to lay the transparent layer 410 on the image tile 310. In some other embodiments, associating the image tile 310 with the transparent layer 410 includes coupling the image tile 310 with a grid texture mapping.

A second exemplary execution of the method referred to as 412 illustrates generating an intermediate rendering result 414 by associating the image tile 308 with a transparent layer 420. In some embodiments of the present technology, the image tile 308 and/or the transparent layer 420 may have similar specifics than the specifics of the image tile 310 and/or the transparent layer 410. In some other embodiments of the present technology, the image tile 308 and/or the transparent layer 420 may have specifics dissimilar to the specifics of the image tile 310 and/or the transparent layer 410. As previously detailed in the paragraphs above, the image tile 308 may represent a different portion of the panorama image 302 than the portion of the panorama image 302 represented by the image tile 310. In some embodiments of the present technology, the transparent layer 410 and the transparent layer 420 are two distinct transparent layers. In some other embodiments of the present technology, the transparent layer 410 and the transparent layer 420 define a same transparent layer.

Still referring to FIG. 4, the merging of the intermediate rendering result 404 with the intermediate rendering result 414 to render a portion 430 of the panorama image 302 is depicted. In some embodiments of the present technology, the merging of the intermediate rendering result 404 with the intermediate rendering result 414 comprises mapping, at least partially, the image tile 310 and the image tile 308 on a two-dimensional surface or on a three-dimensional surface so as to “reconstruct” the portion of the panorama image originally formed by the image tile 310 and the image tile 308. In some alternative embodiments of the present technology, the merging of the intermediate rendering result 404 with the intermediate rendering result 414 comprises overlaying, at least partially, the image tile 310 and the image tile 308 on a two-dimensional surface or on a three-dimensional surface so as to “reconstruct” the portion of the panorama image originally formed by the image tile 310 and the image tile 308. In some embodiments of the present technology, the merging of the intermediate rendering result 404 with the intermediate rendering result 414 comprises juxtaposing, at least partially, the image tile 310 and the image tile 308 on a two-dimensional surface or on a three-dimensional surface so as to “reconstruct” the portion of the panorama image originally formed by the image tile 310 and the image tile 308. At is could be appreciated by a person skilled in the art of the present technology, as each intermediate rendering result comprises an image tile associated with a transparent layer, merging two intermediate rendering results to “reconstruct” a portion of a panorama image is made without any visual interferences resulting from the transparent layers as the transparent layers remain invisible upon displaying the reconstructed portion of the panorama image.

Turning now to FIG. 5, a method 500 of decomposing the panorama image 502 is depicted. The method 500 aims at providing an exemplary embodiment of how a panorama image may be divided into a plurality of image tiles which can then be used in accordance with the present technology to render a panorama image. As illustrated, a grid defining a set of triangles is associated with the panorama image to form a gridded panorama image 504. By applying the grid, the method 500 allows to divide the panorama image 502 into a plurality of image tiles such as, for example, the image tiles 506, 508 and 510. In accordance with some embodiments of the present technology, the image tiles 506, 508 and 510 may be stored in a memory of the server 222 and transmitted via the network 220 to the electronic device 208. Once received by the electronic device 208, the processor 110 and/or the GPU 111 may generate a first intermediate rendering result by associating the image tile 506 with a first transparent layer, a second intermediate rendering result by associating the image tile 508 with a second transparent layer and a third intermediate rendering result by associating the image tile 510 with a third transparent layer. The first, second and third intermediate rendering results may then be stored in the memory 120, 130 of the electronic device 208. Upon receiving an instruction to render at least a portion of the panorama image 502, the electronic device 208 is caused to access first, second and third intermediate rendering results stored in the memory 120, 130. Once accessed, the first, second and third intermediate rendering results may be merged to render a portion of the panorama image 502 formed by the combination of the image tiles 506, 508 and 510. The portion of the panorama image 502 may then be displayed to the user 170 via the display 142 of the electronic device 208. In some embodiments of the present technology, upon receiving the instruction to render the portion of the panorama image, the electronic device 208 may determine that the first, second and third intermediate rendering results stored in the memory 120, 130 are not sufficient to “reconstruct” the required portion of the panorama image 502. In this instance, the electronic device 208 may send a request to the server 222 to obtain additional image tiles that may be required for the rendering of the portion of the panorama image 502. Upon receiving the additional tiles, the electronic device 208 may generate additional intermediate rendering results which, in turn, may be used to render the portion of the panorama image 502.

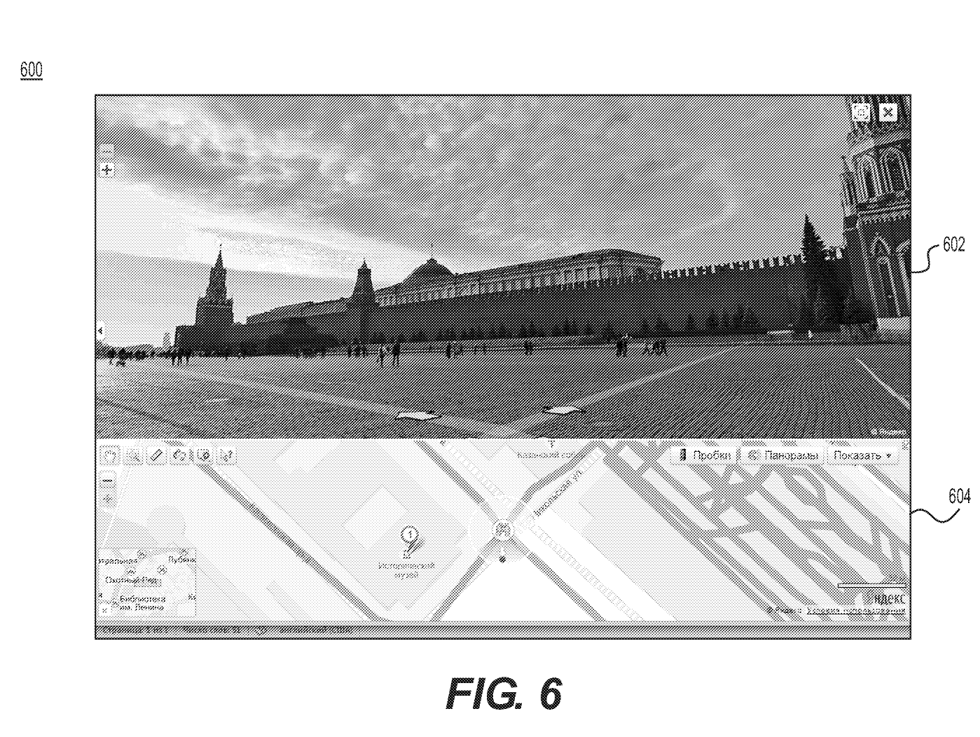

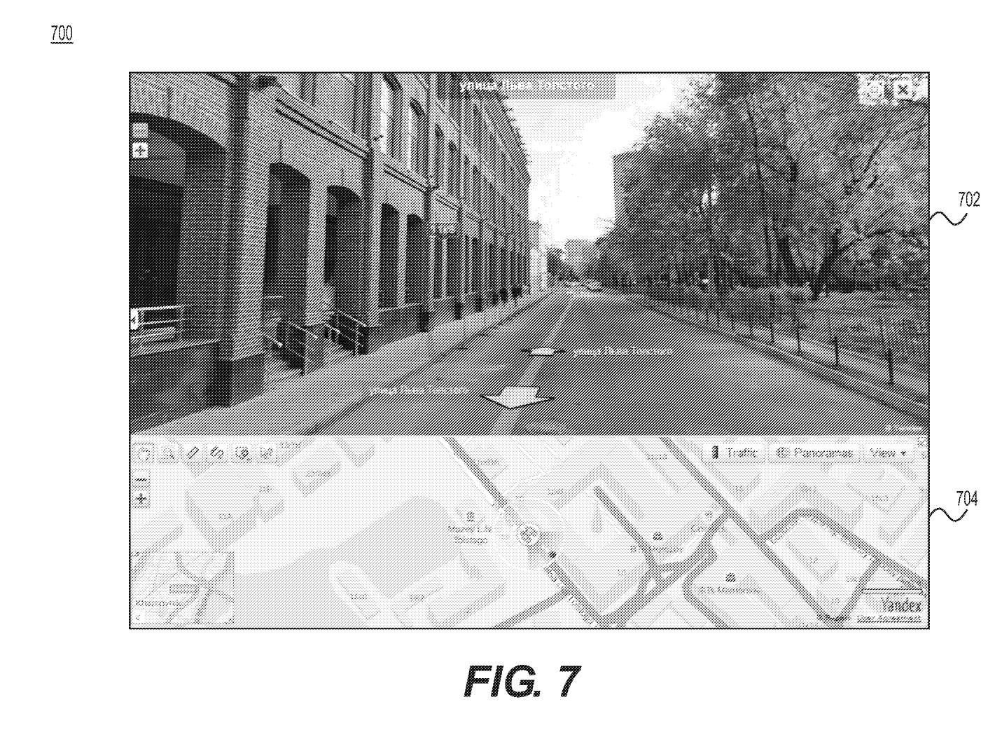

Turning now to FIGS. 6 and 7, exemplary embodiments of a first display 600 and a second display 700 are depicted. The first display 600 comprises a first portion 602 displaying a portion of a panorama image rendered in accordance with the present technology and a second portion 604 displaying a map. The second portion 604 may provide the user 170 with information relating to the localisation of the displayed panorama image. The second portion 604 may also provide the user 170 with information relating to her/his virtual orientation associated with the panorama image. As described above with respect to the first display 600, the second display 700 comprises a first portion 702 and a second portion 704 which are analogous to the first portion 602 and the second portion 604 of the first display 600.

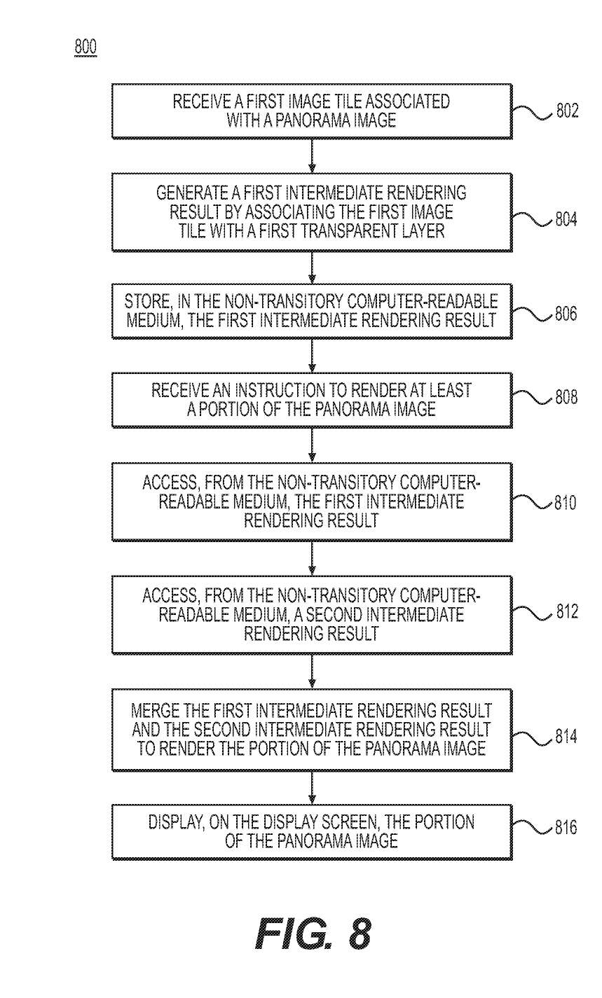

Having described, with reference to FIG. 1 to FIG. 7, some non-limiting example instances of systems and computer-implemented methods used in connection with the problem of rendering a panorama image, we shall now describe a general solution to this problem with reference to FIG. 8.

More specifically, FIG. 8 shows a flow chart of computer-implemented method 800 of rendering a panorama image comprising a first image tile and a second image tile, in accordance with an embodiment of the present technology. The computer-implemented method of FIG. 8 may comprise a computer-implemented method executable by a processor of the server 222 and/or a processor of the electronic device 208, the method comprising a series of steps to be carried out by the server 222 and/or the electronic device 208.

The computer-implemented method of FIG. 8 may be carried out, for example, in the context of the electronic device 208 by the processor 110 and/or the GPU 111 executing program instructions having been loaded into random access memories 130 from solid-state drives 120 of the electronic device 208. In an alternative embodiment, the computer-implemented method of FIG. 8 may be carried out, for example, in the context of the server 222 by the processor 110 and/or the GPU 111 executing program instructions having been loaded into random access memories 130 from solid-state drives 120 of the server 222.

At step 802, the electronic device 208 may receive, from the server 222, via the network 220, a first image tile associated with a panorama image. The panorama image may be a two-dimensional image, a three-dimensional image and/or a volumetric image. The first image tile may be for example, but without being limitative, a triangle tile. The first image tile may correspond to a portion of a sphere associated with the panorama image, the sphere representing the panorama image on a three-dimensional surface.

At step 804, a first intermediate rendering result is generated by associating the first image tile with a first transparent layer. The first transparent layer may have a rectangular shape. In some embodiments of the present technology, the first transparent layer may have a width and height selected so as to fully encompass the first image tile. In accordance with some exemplary embodiments, associating the first image tile with the first transparent layer may include laying the first image tile on the first transparent layer. In yet some embodiments of the present technology, associating the first image tile with the first transparent layer may include coupling the first image tile with a grid texture mapping, the grid texture mapping being associated with the panorama image.

Once generated, the first intermediate rendering result is stored, at step 806, in a non-transitory computer-implemented medium such as, for example, the random access memory 130 and/or the solid-state drive 120 of the electronic device 208.

At step 808, an instruction to render at least a portion of the panorama image may be received. The instruction to render the panorama image may be in response to receiving a display instruction from the server 222 and/or an interaction of the user 170 with the electronic device 208. Upon receiving the instruction to render the portion of the panorama image, the method 800 may proceed by executing steps 810, 812 and 814 that are set forth below.

At step 810, the first intermediate rendering result is accessed from the non-transitory computer-readable medium. At step 812, a second intermediate rendering result is accessed. The second intermediate rendering result comprises a second image tile associated with the panorama image and a second transparent layer. In some embodiments of the present technology, the second transparent layer is analogous to the first transparent layer. In some alternative embodiments, the first transparent layer and the second layer are not analogous. In yet some alternative embodiments, the first transparent layer and the second transparent layer define a same transparent layer. In some alternative embodiments, the first transparent layer and the second transparent layer define two distinct transparent layers.

At step 814, the first intermediate rendering result and the second intermediate result are merged to render the portion of the panorama image. In some embodiments, merging the first intermediate result and the second intermediate result is limited to rendering the portion of the panorama image which is to be displayed on the display screen 142 of the electronic device 208. In some alternative embodiments, merging the first intermediate rendering result and the second intermediate rendering result comprises merging the first image tile and the second image tile only if the first image tile and the second image tile are to be displayed on the display screen 142 of the electronic device 208. In some alternative embodiments, merging the first intermediate rendering result and the second intermediate rendering result includes mapping, at least partially, the first intermediate result and the second intermediate rendering result to a two-dimensional surface or a three-dimensional surface. In some alternative embodiments, merging the first intermediate rendering result and the second intermediate rendering result includes juxtaposing, at least partially, the first image tile and the second image tile on a two-dimensional surface or a three-dimensional surface. In some alternative embodiments, merging the first intermediate rendering result and the second intermediate rendering result includes overlaying, at least partially, the first intermediate rendering result and the second intermediate rendering result.

In some embodiments of the present technology, the method 800 may further include a step of determining whether the portion of the panorama image is to be displayed on the display 142 of the electronic device 208 and, if the first intermediate rendering result and the second intermediate rendering result stored in the non-transitory computer-readable medium are not sufficient to render the portion of the panorama image to be displayed on the display 142, then additional steps may be executed. The additional steps may include requesting, by the electronic device 208, a third image tile associated with the panorama image; and receiving from the server 222, the third image tile. Then, a third intermediate rendering result may be generated by associating the third image tile with a third transparent layer, the third intermediate rendering result comprising the third image tile associated with the third transparent layer. The third intermediate rendering result may then be stored in the non-transitory computer-readable medium of the electronic device 208 and accessed so as to be merged with the first intermediate rendering result, the second intermediate rendering result and the third intermediate rendering result to render the portion of the panorama image to be displayed.

At step 816, the rendered portion of the panorama image may be displayed, for example, on the display 142 of the electronic device 208. In some embodiments of the present technology, the rendered portion of the panorama image may be rendered on the electronic device 208 but displayed on another electronic device such as, for example, but without being limitative, on a display connected to the electronic device 208.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

One skilled in the art will appreciate when the instant description refers to “receiving data” from a user that the electronic device 208 or another electronic device executing receiving of the data from the user may receive an electronic (or other) signal from the user. One skilled in the art will further appreciate that displaying data to the user via a user-graphical interface (such as the screen of the electronic device and the like) may involve transmitting a signal to the user-graphical interface, the signal containing data, which data can be manipulated and at least a portion of the data can be displayed to the user using the user-graphical interface.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1-34. (canceled)

35. An electronic device for rendering a panorama image comprising a first image tile and a second image tile, the first image tile and the second image tile each representing distinct sub-portions of the panorama image and each being associated with a particular position with respect to one another, the electronic device comprising:
a non-transitory computer-readable medium;
a display screen;
a network interface allowing data exchange between the electronic device and a remote server; and
a processor configured to perform:
receiving, from the remote server, the first image tile;
generating a first intermediate rendering result by associating the first image tile with a first transparent layer;
storing, in the non-transitory computer-readable medium, the first intermediate rendering result;
upon receiving an instruction to render at least a portion of the panorama image, executing:
accessing, from the non-transitory computer-readable medium, the first intermediate rendering result;
accessing, from the non-transitory computer-readable medium, a second intermediate rendering result, the second intermediate rendering result comprising the second image tile associated with a second transparent layer, the second image tile being associated with the second transparent layer such as to preserve its particular position with respect to the particular position of the first image tile upon merging the first intermediate rendering result and the second intermediate rendering result; merging the first intermediate rendering result and the second intermediate rendering result to render the portion of the panorama image; and
displaying, on the display screen, the portion of the panorama image.

36. The electronic device of claim 35, wherein the first image tile is a first triangle tile and the second image tile is a second triangle tile.

37. The electronic device of claim 35, wherein the first transparent layer has a width and a height selected so as to fully encompass the first image tile and the second transparent layer has a width and a height selected so as to fully encompass the second image tile.

38. The electronic device of claim 35, wherein the first transparent layer and the second transparent layer each has a rectangular shape.

39. The electronic device of claim 35, wherein merging the first intermediate rendering result and the second intermediate rendering result is limited to rendering the portion of the panorama image which is to be displayed on the display screen.

40. The electronic device of claim 35, wherein merging the first intermediate rendering result and the second intermediate rendering result comprises merging the first image tile and the second image tile only if the first image tile and the second image tile are to be displayed on the display screen.

41. The electronic device of claim 35, wherein the processor is further configured to determine whether the portion of the panorama image is to be displayed on the display screen and, if the first intermediate rendering result and the second intermediate rendering result stored in the non-transitory computer-readable medium are not sufficient to render the portion of the panorama image to be displayed on the display screen, perform:
requesting, to the remote server, a third image tile associated with the panorama image the third image tile representing a distinct sub-portion of the panorama image and being associated with a particular position with respect to the first image tile and the second image tile;
receiving, from the remote server, the third image tile;
generating a third intermediate rendering result by associating the third image tile with a third transparent layer, the third intermediate rendering result comprising the third image tile associated with the third transparent layer, the third image tile being associated with the third transparent layer such as to preserve its particular position with respect to the particular positions of the first image tile and the second image tile upon merging the first intermediate rendering result, the second intermediate rendering result and the third intermediate result;
storing, in the non-transitory computer-readable medium, the third intermediate rendering result;
accessing, from the non-transitory computer-readable medium, the third intermediate rendering result; and
merging the first intermediate rendering result, the second intermediate rendering result and the third intermediate rendering result to render the portion of the panorama image to be displayed.

42. (canceled)

43. The electronic device of claim 35, wherein merging the first intermediate rendering result and the second intermediate rendering result includes one of:
mapping, at least partially, the first intermediate rendering result and the second intermediate rendering result to one of a two-dimensional surface and a three-dimensional surface;
juxtaposing, at least partially, the first image tile and the second image tile on one of a two-dimensional surface and a three-dimensional surface; and
overlaying, at least partially, the first intermediate rendering result and the second intermediate rendering result.

44.-46. (canceled)

47. The electronic device of claim 35, wherein associating the first image tile with the first transparent layer includes one of:
laying the first image tile on the first transparent layer; and
coupling the first image tile with a grid texture mapping, the grid texture mapping being associated with the panorama image.

48. (canceled)

49. The electronic device of claim 35, wherein the panorama image is one of a two-dimensional image and a volumetric image.

50. The electronic device of claim 35, wherein the first transparent layer and the second transparent layer define at least one of: a same transparent layer and two distinct transparent layers.

51. (canceled)

52. A computer-implemented method of rendering a panorama image comprising a first image tile and a second image tile, the first image tile and the second image tile each representing distinct sub-portions of the panorama image and each being associated with a particular position with respect to one another, the method comprising:
receiving, from a remote server, the first image tile;
generating, by a processor, a first intermediate rendering result by associating the first image tile with a first transparent layer;
storing, in a non-transitory computer-readable medium, the first intermediate rendering result;
upon receiving an instruction to render at least a portion of the panorama image, executing:
accessing, from the non-transitory computer-readable medium, the first intermediate rendering result;
accessing, from the non-transitory computer-readable medium, a second intermediate rendering result, the second intermediate rendering result comprising the second image tile associated with a second transparent layer, the second image tile being associated with the second transparent layer such as to preserve its particular position with respect to the particular position of the first image tile upon merging the first intermediate rendering result and the second intermediate rendering result;
merging the first intermediate rendering result and the second intermediate rendering result to render the portion of the panorama image; and
displaying, on a display screen, the portion of the panorama image.

53. (canceled)

54. The method of claim 52, wherein the first transparent layer has a width and a height selected so as to fully encompass the first image tile and the second transparent layer has a width and a height selected so as to fully encompass the second image tile.

55. The method of claim 52, wherein the first transparent layer and the second transparent layer each has a rectangular shape.

56. The method of claim 52, wherein merging the first intermediate rendering result and the second intermediate rendering result is limited to rendering the portion of the panorama image which is to be displayed on the display screen.

57. The method of claim 52, wherein merging the first intermediate rendering result and the second intermediate rendering result comprises merging the first image tile and the second image tile only if the first image tile and the second image tile are to be displayed on the display screen.

58. The method of claim 52, further comprising determining whether the portion of the panorama image is to be displayed on the display screen and, if the first intermediate rendering result and the second intermediate rendering result stored in the non-transitory computer-readable medium are not sufficient to render the portion of the panorama image to be displayed on the display screen, perform:
requesting a third image tile associated with the panorama image, the third image tile representing a distinct sub-portion of the panorama image and being associated with a particular position with respect to the first image tile and the second image tile;
receiving the third image tile;
generating a third intermediate rendering result by associating the third image tile with a third transparent layer, the third intermediate rendering result comprising the third image tile associated with the third transparent layer, the third image tile being associated with the third transparent layer such as to preserve its particular position with respect to the particular positions of the first image tile and the second image tile upon merging the first intermediate rendering result, the second intermediate rendering result and the third intermediate result;
storing, in the non-transitory computer-readable medium, the third intermediate rendering result;
accessing, from the non-transitory computer-readable medium, the third intermediate rendering result; and
merging the first intermediate rendering result, the second intermediate rendering result and the third intermediate rendering result to render the portion of the panorama image to be displayed.

59. (canceled)

60. The method of claim 52, wherein merging the first intermediate rendering result and the second intermediate rendering result includes one of:
mapping, at least partially, the first intermediate rendering result and the second intermediate rendering result to one of a two-dimensional surface and a three-dimensional surface;
juxtaposing, at least partially, the first image tile and the second image tile on one of a two-dimensional surface and a three-dimensional surface; and
overlaying, at least partially, the first intermediate rendering result and the second intermediate rendering result.

61.-63. (canceled)

64. The method of claim 52, wherein associating the first image tile with the first transparent layer includes one of:
laying the first image tile on the first transparent layer; and
coupling the first image tile with a grid texture mapping, the grid texture mapping being associated with the panorama image.

65.-66. (canceled)

67. The method of claim 52, wherein the first transparent layer and the second transparent layer define at least one of: a same transparent layer and two distinct transparent layers.

68. (canceled)
